(19) United States
(12) Patent Application Publication
(10) Pub. No.: US 2007/0012489 A1
(43) Pub. Date: Jan. 18, 2007

(54) Display device and portable wireless terminal having the same

(76) Inventors: Young Kim, Seoul (KR); Yong-Hui Lee, Suwon-si (KR)

Correspondence Address: CANTOR COLBURN, LLP, 55 GRIFFIN ROAD SOUTH, BLOOMFIELD, CT, 06002, US

(21) Appl. No.: 11/486,786

(22) Filed: Jul. 14, 2006

(30) Foreign Application Priority Data
Jul. 14, 2005 (KR) 2005-63519

(51) Int. Cl. G08C 21/00; G06K 11/06

(52) U.S. Cl. 178/18.01; 345/156; 345/168

(57) ABSTRACT

A display device includes a display module and a flexible circuit film. The display module includes a display panel for displaying images and a light supplying unit for supplying the display panel with a light. The flexible circuit film is electrically connected to the display panel and is disposed on a surface of the display module. The flexible circuit film includes a conductive pattern of driving circuits for driving the display module. The conductive pattern includes multiple conductive layers no less than three. The flexible circuit film also has a light source driving circuit to drive a light emitting diode.

The present application claims priority to Korean Patent Application No. 2005-63519, filed on Jul. 14, 2005, and the benefits accruing therefrom under 35 U.S.C. §119, the contents of which are herein incorporated by reference in its. entirety.

### BACKGROUND OF THE INVENTION

1. Field of the Invention

The present invention relates to a display device and a wireless terminal having the display device. More particularly, the present invention relates to a display device having a reduced thickness and manufacturing cost and a portable wireless terminal having the display device.

2. Description of the Related Art

A portable wireless terminal, in general, includes an information processing device and a display device. The information processing device processes information based on data input signals. The display device displays images based on the information that is processed by the information processing device.

Generally, there are three types of portable wireless terminals: a bar type portable wireless terminal, a flip type portable wireless terminal, and a folding type portable wireless terminal.

In a bar type portable wireless terminal, generally an information processing device and a display device are mounted on one main body housing. A data input member, for example a keypad, is generally exposed to the surrounding environment where the keypad may be more subject to malfunction. In addition, a distance between a transmitter and a receiver may be greater so that a size of the bar type portable wireless terminal may increase.

The flip type portable wireless terminal generally includes a main body, a flip member, and a hinge. In a flip type portable wireless terminal, generally an information processing device and a display device are mounted on the main body. The hinge connects the main body to the flip member. The main body further includes a data input member, a data output member, a transmitter, and a receiver. The flip member generally covers the data input member, for example a keypad, to prevent a malfunction of the data input member. However, a distance between a transmitter and a receiver may also be greater so that a size of the flip type portable wireless terminal may increase.

The folding type portable wireless terminal generally includes a main body, a folding member, and a hinge. In a folding type portable wireless terminal, generally an information processing device is mounted on the main body, while a display device is mounted on the folding member. The hinge connects the main body to the folding member so that the folding member rotates with respect to the main body to expose or cover the keypad. Generally, when the folding type portable wireless terminal is not being used, the folding member is used to cover the keypad to effectively prevent a malfunction of the folder type portable wireless terminal. When the folding type portable wireless terminal is being used, the folding member is opened to expose the keypad so that the transmitter is spaced apart from the receiver by a predetermined distance. Therefore, a size of the folding type portable wireless may decrease.

A sliding type portable wireless terminal generally includes a housing for an information processing device and a counter housing for a display device. The counter housing generally slides on the housing so that a keypad is exposed or covered.

The sliding type portable wireless terminal may further include a printed circuit board (PCB) and a flexible circuit film. The PCB has a display module for displaying images and a plurality of driving modules for driving the display module. The flexible circuit film electrically connects the display module to the PCB.

The display module and the keypad may be fixed to a front surface of the PCB. The PCB may further include a connecter for electrically connecting the flexible circuit film, a plurality of connectors for electrically connecting the driving modules, and the information processing device.

Accordingly, there is a desire to provide a sliding type portable wireless terminal including a flexible circuit film and a PCB, wherein the sliding type portable wireless terminal has a reduced thickness and manufacturing cost.

### SUMMARY OF THE INVENTION

The present invention provides a display device that has a decreased thickness and can be manufactured with a lowered cost.

The present invention also provides a wireless terminal having the display device.

A display device in accordance with an exemplary embodiment of the present invention includes a display module and a flexible circuit film. The display module includes a display panel for displaying images and a light supplying unit for supplying the display panel with a light. The flexible circuit film is electrically connected to the display panel and is disposed on a surface of the display module. The flexible circuit film includes a conductive pattern of driving circuits for driving the display module.

The light supplying unit may include at least one light emitting diode that is electrically connected to the flexible circuit film.

The flexible circuit film may further include a light source driving circuit for driving the light emitting diode. The flexible circuit film may further include a first connector that receives an externally provided control signals to control the display device.

The display device may further include a pad circuit board that has a plurality of keypads for selecting modes of operation. The flexible circuit film may further include a second connector electrically connected to the pad circuit board.

A portable wireless terminal in accordance with another exemplary embodiment of the present invention includes an information processing device and a display device. The information processing device processes information based on input signals of a key input unit. The display device is slidingly combined with the information processing device so that the information processing device is exposed or covered. The display device includes a display module and a flexible circuit film. The display module includes a display panel for displaying images and a light supplying unit for supplying the display panel with a light. The flexible circuit film is electrically connected to the display panel and is disposed on a surface of the display module. The flexible circuit film includes a conductive pattern of driving circuits for driving the display module.

### BRIEF DESCRIPTION OF THE DRAWINGS

The above and other advantages of the present invention will become more apparent by describing in detail exemplary embodiments thereof with reference to the accompanying drawings, in which:

FIG. 1 is a perspective view showing an exemplary embodiment of a portable wireless terminal in accordance with the present invention;

FIG. 2 is a perspective view showing an exemplary embodiment of an inside portion of a display device shown in FIG. 1;

FIG. 3 is a cross-sectional view showing an exemplary embodiment of a flexible circuit film that may be utilized with the display device shown in FIG. 2;

FIG. 4 is an exploded perspective view showing an exemplary embodiment of the display device shown in FIG. 2;

FIG. 5 is a cross-sectional view showing an exemplary embodiment of the display device shown in FIG. 2;

FIG. 6 is a plan view showing an exemplary embodiment of a side of the display device shown in FIG. 2; and

FIG. 7 is a plan view showing an exemplary embodiment of a display panel shown in FIG. 4.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

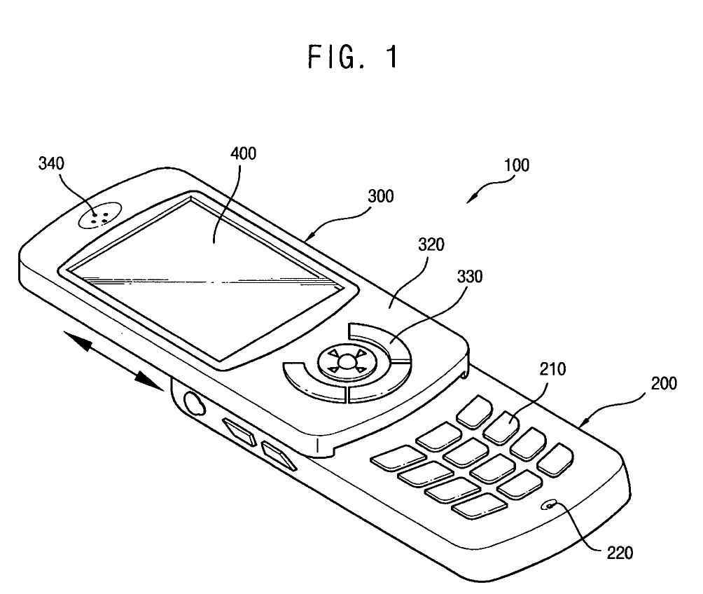

FIG. 1 is a perspective view showing an exemplary embodiment of a portable wireless terminal in accordance with the present invention.

Referring to FIG. 1, the portable wireless terminal 100 includes an information processing device 200 and a display device 300.

In an exemplary embodiment, the information processing device 200 processes information based on input signals from a key input unit 210. The information processing device 200 includes the key input unit 210 and a main circuit board (not shown). The main circuit board applies control signals based on the input signals from the key input unit 210 to drive the display device 300. In addition, the information processing unit 200 further includes a microphone 220 for transforming voice data into electric signals.

The display device 300 may be combined with the information processing device 200 to display images based on control signals from the information processing device 200.

In an exemplary embodiment, the display device 300 slides on the information processing device 200 along a longitudinal direction of the information processing device 200 to expose or cover the information processing device 200. For example, when the portable wireless terminal 100 is not being used, the display device 300 may substantially cover the information processing device 200 to effectively prevent a malfunction of the portable wireless terminal 100. When the portable wireless terminal 100 is being used, the display device 300 may slide toward an upper portion of the information processing device 200 to expose the key input unit 210 and the microphone 220.

The display device 300 includes a display module 400 and a case 320. The display module 400 is configured to display images, and may be received in the case 320. The display device 300 may include a plurality of key input buttons 330 and a speaker 340. The key input buttons 330 may select modes of operation such as a power level, a call, etc.

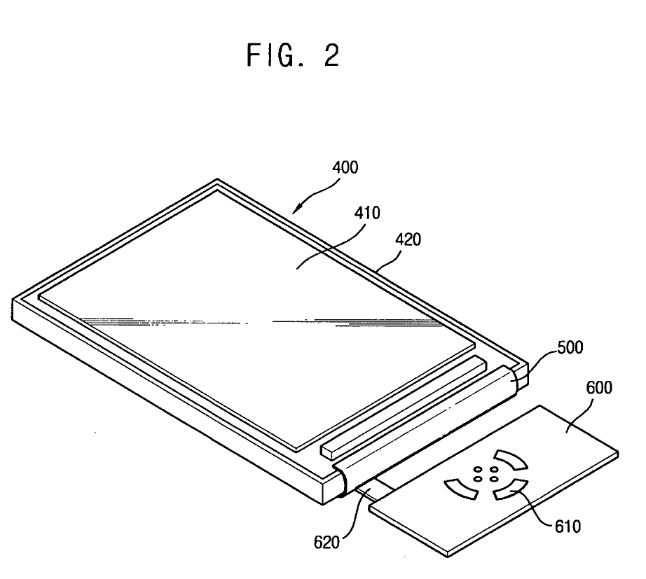

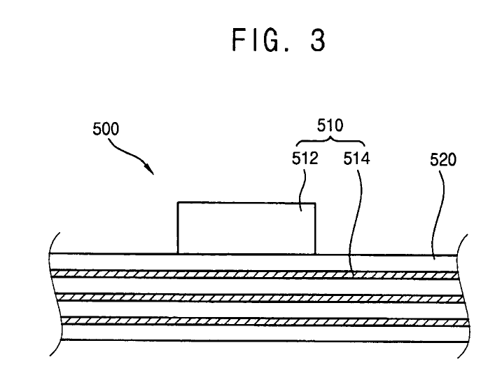

FIG. 2 is a perspective view showing an exemplary embodiment of an inside portion of a display device shown in FIG. 1. FIG. 3 is a cross-sectional view showing an exemplary embodiment of a flexible circuit film that may be utilized with the display device shown in FIG. 2.

Referring to FIGS. 2 and 3, in an exemplary embodiment, the display device 300 includes the display module 400 and a flexible circuit film 500. The flexible circuit film 500 is electrically connected to the display module 400.

The display module 400 includes a display panel 410 and a light supplying unit 420. The display panel 410 is configured to display images. The light supplying unit 420 supplies the display panel 410 with light. The light supplying unit 420 may be disposed under the display panel 410 to supply the display panel 410 with the light.

In an exemplary embodiment, the flexible circuit film 500 may be electrically connected to an end portion of the display panel 410, and extend toward a rear side of the display module 400.

In this embodiment, the flexible circuit film 500 includes a plurality of driving circuits 510 for driving the display module 400. The driving circuits 510 include a plurality of circuit elements 512 and a conductive pattern 514. The conductive pattern 514 transmits electric signals to the circuit elements 512. In an exemplary embodiment, when the number of the circuit elements 512 are increased, the number of conductive layers of the conductive pattern 514 is no less than three, so that the conductive pattern 514 may not be electrically connected to all of the circuit elements 512 with a mono layered conductive pattern or a double layered conductive pattern.

In FIGS. 2 and 3, for example, the conductive pattern 514 has three conductive layers. The flexible circuit film 500 also includes insulating layers 520 and each conductive layer is disposed between adjacent ones of the insulating layers 520.

In an alternative exemplary embodiment, when the flexible circuit film 500 includes the conductive pattern 514 having more than three layers, a plurality of driving circuits 510 may be formed on the flexible circuit film 500. Therefore, a printed circuit board (PCB) for the circuit elements 512 may be omitted to decrease a manufacturing cost and a thickness of the display device 300.

For example, a thickness of the PCB may be about 1 mm, and a thickness of each of the conductive layers may be about 0.1 mm. In an exemplary embodiment illustrated in FIGS. 2 and 3, the number of the conductive layers is increased, and the PCB is omitted so that a total thickness of the display device 300 is decreased by about 0.9 mm.

The display device 300 may further includes a pad circuit board 600 having a plurality of keypads 610 for selecting modes of operation, such as but not limited to, selecting a power level, selecting a call mode, etc. Each of the keypads 610 may correspond to each of the key input buttons 330 shown in FIG. 1.

In an exemplary embodiment, the pad circuit board 600 is spaced apart from the flexible circuit film 500 so that the pad circuit board 600 is electrically connected to the flexible circuit film 500 through additional lines. The pad circuit board 600 has a smaller thickness than the display module 400.

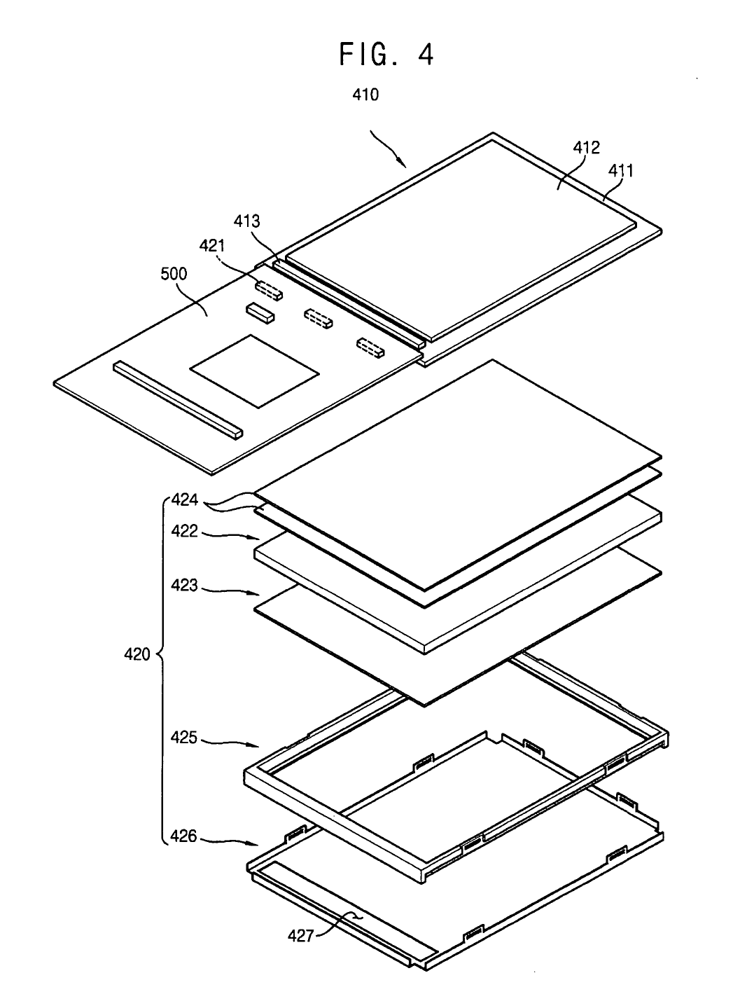

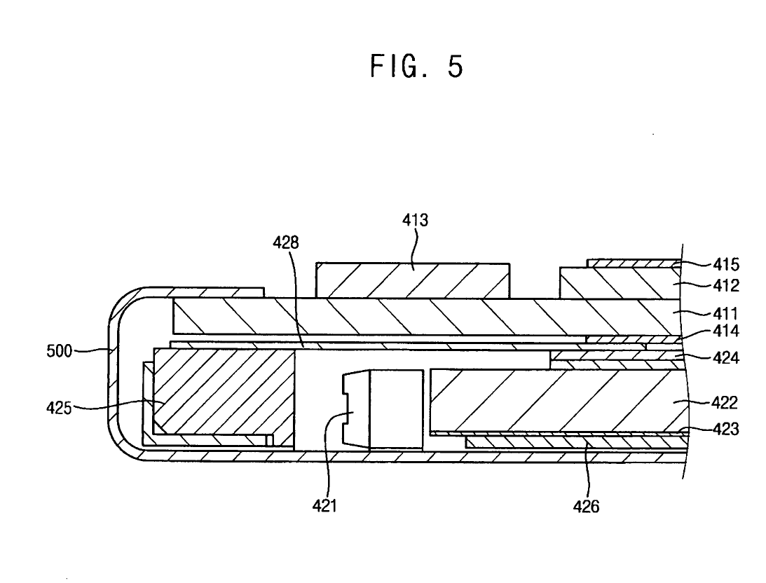

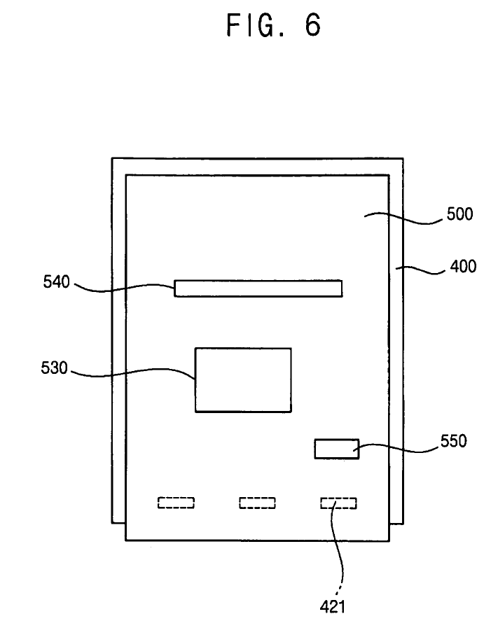

FIG. 4 is an exploded perspective view showing an exemplary embodiment of the display device shown in FIG. 2. FIG. 5 is a cross-sectional view showing an exemplary embodiment of the display device shown in FIG. 2. FIG. 6 is a plan view showing an exemplary embodiment of a side of the display device shown in FIG. 2.

Referring to FIGS. 4 and 5, the display module 400 includes the display panel 410 and the light supplying unit 420. The display panel 410 is configured to display images. The light supplying unit 420 supplies the display panel 410 with light.

In an exemplary embodiment, the light supplying unit 420 includes at least one light emitting diode 421, a light guiding plate 422, a reflection sheet 423, at least one optical sheet 424, a mold frame 425, and a bottom chassis 426.

At least one of the light emitting diodes 421 is electrically connected to the flexible circuit film 500. The light emitting diode 421 may include a white light emitting diode that generates white light. The number of the light emitting diodes 421 may be changed in response to a size of the display panel 410 and a luminance of the light that is irradiated onto the display panel 410.

The flexible circuit film 500 may be bent toward the bottom chassis 426 so that the light emitting diode 421 is on a side of the light guiding plate 422. For example, the light emitting diode 421 is adjacent to the side of the light guiding plate 422 through an opening 427 of the bottom chassis 426.

The light guiding plate 422 guides the light generated from the light emitting diode 421 toward the display panel 410. The light guiding plate 422 may include a transparent material so that the light generated from the light emitting diode 421 may pass through the light guiding plate 422. For example, the light guiding plate 422 includes polymethyl methacrylate (PMMA).

In alternative embodiments, in order to decrease a thickness of the light guiding plate 422, the light guiding plate 422 may include a polycarbonate (PC). The polycarbonate (PC) may have lower mechanical resistance and greater heat resistance than the polymethyl methacrylate (PMMA).

In an exemplary embodiment, a reflecting pattern (not shown) may be formed on a surface of the light guiding plate 422. A light is reflected from the reflection pattern. For example, the reflection pattern may be a printed pattern or an embossed pattern. The light generated from the light emitting diode 421 is incident into the light guiding plate 422, and the light is reflected from the reflection pattern to be scattered. When an incident angle of the light that is irradiated onto a surface of the light guiding plate 422 is greater than a critical angle, the light exits from the light guiding plate 422 toward the display panel 410.

In an exemplary embodiment, the reflection sheet 423 is disposed under the light guiding plate 422. The light from a lower surface of the light guiding plate 422 may be reflected from the reflection sheet 423 toward the display panel 410 to improve a luminance of the display panel 410.

The reflection sheet 423 may include a highly reflective material. Examples of highly reflective material that may be used for the reflection sheet 423 include polyethyleneterephthalate (PET) or polycarbonate (PC).

In an exemplary embodiment, the optical sheets 424 are disposed on the light guiding plate 422. The optical sheets 424 may improve optical characteristics of the light that has passed through the light guiding plate 422. The optical sheets 424 may include a prism sheet that increases a luminance of the display panel 410. The optical sheets 424 may further include a reflective polarizing sheet that transmits a portion of the light and reflects a remaining portion of the light to recycle the light to improve the luminance of the display panel 410. The light supplying unit 420 may further include additional optical sheets to further improve the luminance of the display panel 410.

The optical sheets 424 may be secured to the mold frame 425, for example, by an adhesive tape 428. The display panel 410 may be also secured to the optical sheets 424, for example, by the adhesive tape 428. Additionally, the adhesive tape may be a dark color for blocking light. For example, the adhesive tape 428 may be a black color to block light from a space between the light emitting diode 421 and the light guiding plate 422.

In an exemplary embodiment, the mold frame 425 may have a substantially quadrangular shape to receive the light emitting diode 421, the light guiding plate 422, the reflection sheet 423, and the optical sheets 424. The mold frame 425 may include a plastic resin.

The bottom chassis 426 is combined with the mold frame 425 to cover a lower surface of the reflection sheet 423. For example, the bottom chassis 426 may be made of metal and have a greater strength than the mold frame 425. In an exemplary embodiment, the mold frame 425 may have a hook portion for securing the mold frame 425 to the bottom chassis 426. In this embodiment, the bottom chassis 426 has the opening 427 to receive the light emitting diode 421.

In an exemplary embodiment, the display panel 410 is disposed on the light supplying unit 420, and displays images using the light generated from the light supplying unit 420.

In this embodiment, the display panel 410 includes a lower substrate 411, an upper substrate 412, a liquid crystal layer (not shown), and a driving chip 413. The upper substrate 412 is disposed facing the lower substrate 411, and may be combined with the lower substrate 411. The liquid crystal layer is disposed between the lower substrate 411 and the upper substrate 412. The driving chip 413 may be disposed on the lower substrate 411. In alternative embodiments, the display panel 410 may be an organic light emitting display (OLED) panel having an organic light emitting element.

The driving chip 413 generates driving signals based on the control signals sent from the flexible circuit film 500 to the display panel 410.

Referring to FIG. 5, display panel 410 may include a first polarizer 414 and a second polarizer 415. The first and second polarizers 414 and 415 may be attached to a lower substrate 411 and the upper substrate 412, respectively. For example, the first polarizer 414 may have a polarizing axis that is substantially perpendicular to the second polarizer 415.

In this embodiment, the flexible circuit film 500 may be electrically connected to an end portion of the lower substrate 411 having the driving chip 413. For example, the flexible circuit film 500 may be electrically connected to the lower substrate 411 through an anisotropic conductive film (ACF).

The flexible circuit film 500 is bendable and extends toward a rear surface of the bottom chassis 426. The flexible circuit film 500 may be configured to be secured to the rear surface of the bottom chassis 426. For example, the flexible circuit film 500 may be secured to the bottom chassis 426 with a double sided tape.

Referring to FIG. 6, a light source driving circuit 530 is formed on the flexible circuit film 500 to drive the light emitting diode 421. In FIGS. 1 to 6, the number of the conductive layers of the conductive pattern 514 is no less than three so that the light source driving circuit 530 may be formed on the flexible circuit film 500.

The light emitting diode 421 and the light driving circuit 530 may be formed on the flexible circuit film 500 so that a connecting line for electrically connecting the light emitting diode 421 to the light source driving circuit 530 may be omitted.

The flexible circuit film 500 may further include a first connector 540 configured to receive control signals from the main circuit board of the information processing device 200 (shown in FIG. 1). The control signals applied from the information processing device 200 to the first connector 540 may include a panel driving signal for driving the display panel 410, and a light source control signal that is applied to the light source driving circuit 530 to control the light emitting diode 421, etc.

In alternative embodiments, the flexible circuit film 500 may further include a second connector 550 for electrically connecting the flexible circuit film 500 to the pad circuit board 600 (shown in FIG. 2). The pad circuit board 600 may be spaced apart from the flexible circuit film 500 so that a connecting line 620 electrically connects the pad circuit board 600 with the second connector 550 of the flexible circuit film 500.

In an exemplary embodiment (although not shown in the figures), the flexible circuit film 500 may further include a driving circuit for driving a speaker, a driving circuit for driving a vibrator, a driving circuit for driving a flash, etc.

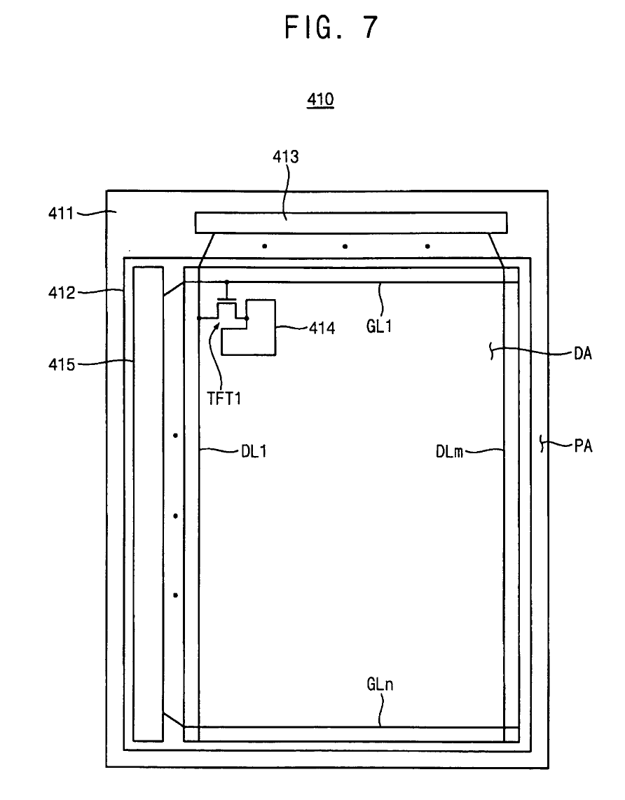

FIG. 7 is a plan view showing an exemplary embodiment of a display panel shown in FIG. 4.

Referring to FIG. 7, the display panel 410 includes the lower substrate 411, the upper substrate 412, the liquid crystal layer (not shown), and the driving chip 413. The upper substrate 412 is disposed facing the lower substrate 411, and may be combined with the lower substrate 411. The liquid crystal layer is disposed between the lower substrate 411 and the upper substrate 412. The driving chip 413 is formed on the lower substrate 411.

The display panel 410 may be divided into a display region DA and a peripheral region PA. Images are displayed in the display region DA. The peripheral region PA generally surrounds the display region DA.

A plurality of gate lines GL1, . . . GLn and a plurality of data lines DL1, DLm may be formed on the lower substrate 411 in the display region DA (here, ‘n’ and ‘m’ are natural numbers). The data lines DL1, . . . DLm traverse the gate lines GL1, . . . GLn. The gate lines GL1, . . . GLn may be formed on a different layer from the data lines DL1, . . . DLm so that the gate lines GL1, . . . GLn are electrically insulated from the data lines DL1, . . . DLm.

In an exemplary embodiment, a plurality of thin film transistors (TFTs) and a plurality of pixel electrodes may be formed on the lower substrate 411 in the display region DA in a matrix shape. For example, a gate electrode, a source electrode, and a drain electrode of a first TFT TFT1 are electrically connected to a first gate line GL1, a first data line DL1, and a first pixel electrode 414, respectively.

A gate driving circuit part 415 may be formed on the lower substrate 411 in the peripheral region PA to drive the gate lines GL1, . . . GLn. The gate driving circuit part 415 may include a shift register having a plurality of driving transistors. The gate driving circuit part 415 may apply gate driving signals sequentially to the gate lines GL1, . . . GLn based on gate control signals from the flexible circuit film 500. The gate driving circuit part 415 may be formed from a process substantially similar to the process used to form the gate lines GL1, . . . GLn, the data lines DL1, . . . DLm and the TFTs.

The upper substrate 412 may include a color filter layer (not shown) and a common electrode (not shown). The color filter layer is employed to display color images. The common electrode corresponds to the pixel electrodes of the lower substrate 411. Alternatively, the color filter layer may be formed on the lower substrate 411.

The liquid crystal layer may be disposed between the lower substrate 411 and the upper substrate 412. Further, the liquid crystal layer may include a plurality of liquid crystal molecules having electrical and optical characteristics. Examples of the electrical and optical characteristics of the liquid crystal molecules include a dielectric anisotropy, an optical anisotropy, etc. For example, the liquid crystal layer includes twisted nematic liquid crystal molecules that change orientation in response to an electric field applied thereto.

The driving chip 413 may be disposed in the peripheral region PA of the lower substrate 411. For example, the driving chip 413 is electrically connected to the lower substrate 411 through the anisotropic conductive film (ACF).

The driving chip 413 may apply data driving signals to the data lines DL1, . . . DLm based on control signals from the flexible circuit film 500.

When electric power is applied to the gate electrode of the thin film transistor, an electric field is formed between the pixel electrode and the common electrode. An arrangement of the liquid crystal molecules between the lower substrate 411 and the upper substrate 412 may vary in response to the electric field applied thereto so that a light transmittance of the liquid crystal layer changes, thereby displaying images.

As described above in the exemplary embodiments of the present invention, the flexible circuit film has conductive patterns of no less than three layers so that the driving circuits may be formed on the flexible circuit film. In addition, the number of the elements may be decreased. Therefore, the printed circuit board having a greater thickness than the flexible circuit film may be omitted to decrease the manufacturing cost and the thickness of the display device.

This invention has been described with reference to the exemplary embodiments. It is contemplated, however, that many alternative modifications and variations would be apparent to those having skill in the art in light of the foregoing description. Accordingly, the present invention embraces all such alternative modifications and variations as fall within the spirit and scope of the appended claims.

What is claimed is:

1. A display device comprising:
a display module including a display panel for displaying images and a light supplying unit for supplying the display panel with a light; and
a flexible circuit film electrically connected to the display panel and being disposed on a surface of the display module, the flexible circuit film including a conductive pattern of driving circuits for driving the display module.

2. The display device of claim 1, wherein the light supplying unit comprises at least one light emitting diode that is electrically connected to the flexible circuit film.

3. The display device of claim 1, wherein the conductive pattern of the driving circuits includes conductive layers of which number is no less than three.

4. The display device of claim 2, wherein the flexible circuit film further comprises a light source driving circuit for driving the light emitting diode.

5. The display device of claim 2, wherein the light supplying unit further comprises:
a light guiding plate that guides the light generated from the light emitting diode toward the display panel;
a reflection sheet disposed under the light guiding plate;
an optical sheet disposed on the light guiding plate;
a mold frame that receives the light emitting diode, the light guiding plate, the reflection sheet, and the optical sheet; and
a bottom chassis combined with the mold frame to cover a lower surface of the reflection sheet.

6. The display device of claim 5, wherein the flexible circuit film is secured to a surface of the bottom chassis.

7. The display device of claim 6, wherein the bottom chassis includes an opening at a selected position, the light emitting diode being disposed adjacent to a side of the light guide plate through the opening of the bottom chassis.

8. The display device of claim 1, wherein the flexible circuit film further comprises a first connector that receives control signals for controlling the display device.

9. The display device of claim 1, wherein the display panel is a liquid crystal display panel that comprises:
a lower substrate;
an upper substrate combined with the lower substrate;
a liquid crystal layer disposed between the lower substrate and the upper substrate; and
a driving chip mounted on the lower substrate.

10. The display device of claim 1, further comprising a pad circuit board including a plurality of keypads for selecting modes of operation.

11. The display device of claim 10, wherein the flexible circuit film further comprises a second connector electrically connected to the pad circuit board.

12. A portable wireless terminal comprises:
an information processing device that processes information based on input signals of a key input unit; and
a display device for displaying images, the display device slidingly combined with the information processing device so that the information processing device is exposed or covered, the display device including:
a display module including a display panel for displaying images and a light supplying unit for supplying the display panel with a light; and
a flexible circuit film electrically connected to the display panel and being disposed on a surface of the display module, the flexible circuit film including a conductive pattern of driving circuits for driving the display module.

13. The display device of claim 12, wherein the conductive portion of the driving circuits includes conductive layers of which number is no less than three.

14. The mobile wireless terminal of claim 11, wherein the flexible circuit film further comprises a light source driving circuit for driving at least one light emitting diode of the light supplying unit.

15. The mobile wireless terminal of claim 11, wherein the information processing device comprises a main circuit board that generates control signals for controlling the display device.

16. The mobile wireless terminal of claim 15, wherein the flexible circuit film further comprises a first connector electrically connected to the main circuit board.

17. The mobile wireless terminal of claim 16, wherein the display device further comprises a pad circuit board including a plurality of keypads for selecting modes of operation.

18. The mobile wireless terminal of claim 17, wherein the flexible circuit film further comprises a second connector electrically connected to the pad circuit board.

19. The mobile wireless terminal of claim 18, further comprising a connection line electrically connected between the pad circuit board and the second connector of the flexible circuit film.

20. The mobile wireless terminal of claim 12, wherein the light supplying unit comprises:
a light emitting diode electrically connected to the flexible circuit film;
a light guiding plate that guides the light from the light emitting diode; and
a bottom chassis combined with a mold frame that receives the light emitting diode and the light guiding plate.

21. The mobile wireless terminal of claim 20, wherein the flexible circuit film extends toward a rear surface of the bottom chassis.

22. The mobile wireless terminal of claim 21, wherein the bottom chassis includes an opening at a position corresponding to the light emitting diode of the light supplying unit, the light emitting diode being disposed adjacent to a side of the light guide plate through the opening of the bottom chassis.
